(19) United States
(12) Patent Application Publication
(10) Pub. No.: US 2009/0008205 A1
(43) Pub. Date: Jan. 8, 2009

(54) One-way clutch

(76) Inventor: Masayuki Ishida, Kuwana (JP)

Correspondence Address: WENDEROTH, LIND & PONACK, L.L.P., 2033 K STREET N. W., SUITE 800, WASHINGTON, DC, 20006-1021, US

(21) Appl. No.: 12/216,368

(22) Filed: Jul. 2, 2008

(30) Foreign Application Priority Data
Jul. 4, 2007 (JP) 2007-176045
Sep. 25, 2007 (JP) 2007-247498

(51) Int. Cl. F16D 15/00

(52) U.S. Cl. 192/45

(57) ABSTRACT

A one-way clutch includes inner and outer races which define circumferentially arranged wedge-shaped spaces, and clutch-actuating rollers received in the respective wedge-shaped spaces. Load-bearing rollers are provided between the circumferentially adjacent clutch-actuating rollers. The biasing force applied to one of the clutch-actuating rollers from an elastic member is transmitted to the circumferentially adjacent clutch-actuating roller through the load-bearing roller disposed therebetween. The biasing force biases the respective clutch-actuating rollers toward the narrow ends of the respective wedge-shaped spaces, and biases the load-bearing rollers against a cylindrical surface of the outer race having its center located on the axis of the outer race. Because the biasing force is not transmitted through a retainer, no high dimensional accuracy is required for the retainer. Thus, the one-way clutch can be easily manufactured and assembled. Still, it shows high locking capacity.

### BACKGROUND OF THE INVENTION

This invention relates to a one-way clutch including rollers as engaging elements.

One-way clutches including engaging elements are widely used for rotary shafts of driving portions of electronic devices and office machines, rotary shafts of automotive engine accessories such as alternators and motors, and rotary shafts of various other devices and machinery.

Some of these one-way clutches include rollers as engaging elements, while others include sprags as engaging elements.

FIG. 14 shows a one-way clutch including rollers as engaging elements. This one-way clutch includes a shaft as an inner race 2, and an annular outer race 1 provided around the inner race 2. In the radially inner surface of the outer race 1, a plurality of pockets 3 are formed at equal circumferential intervals.

As shown in FIG. 14, the pockets 3 are open at least at one axial end of the outer race. On the radially inwardly facing surface of each pocket 3, a cam surface 4 is formed which is inclined radially outwardly in one circumferential direction of the outer race, thus defining a circumferentially wedge-shaped space between the cam surface 4 and the outer periphery 2a of the inner race 2.

In each pocket 3, a clutch-actuating roller 10 is received which is biased by an elastic member 5, which is also received in the pocket, toward the narrow circumferential end of the wedge-shaped space to bring the roller 10 into wedging engagement between the outer periphery 2a of the inner race 2 and the cam surface 4.

When the outer race 1 and the inner race 2 begin to rotate in one direction relative to each other, the rollers 10 are wedged between the outer periphery 2a of the inner race 2 and the cam surfaces 4, so that the outer race 1 and the inner race 2 are locked together and rotate together.

When the outer race 1 and the inner race 2 begin to rotate in the opposite direction relative to each other, the rollers 10 disengage, thus uncoupling the outer race 1 and the inner race 2 from each other, so that the outer race 1 and the inner race 2 become freely rotatable independently of each other.

While the one-way clutch is disengaged, the elastic members 5 keep lightly pressing the rollers 10, thereby keeping the rollers 10 pressed against the cam surfaces 4 and the outer periphery 2a of the inner race 2 (stand-by position). By keeping the rollers in the stand-by position, the one-way clutch operates stably (as disclosed in JP Patent Publication 2000-356230A).

In the one-way clutch shown in FIGS. 15A and 15B, a continuous annular space is defined between the inner periphery 1a of the outer race 1 and the outer periphery 2a of the inner race 2. A plurality of cam surfaces 4 are formed on one of the inner periphery 1a of the outer race 1 and the outer periphery 2a of the inner race 2 to define a plurality of circumferentially arranged wedge-shaped spaces arranged in the circumferential direction. A roller 10 as an engaging element is received in each wedge-shaped space.

As shown in FIG. 15A, the rollers 10 are circumferentially spaced from each other by a first retainer 6 having a ring portion 6a at one axial end of the outer race, and a second retainer 7 having a ring portion 7a at the other axial end of the outer race, and bridges 7b axially extending from the ring portion 7a.

The first retainer 6 is fixedly pressed in the outer race 1. The second retainer 7 is circumferentially movably received in the annular space.

A circumferentially extending elastic member (spring) 5 is coupled to one of the first and second retainers 6 and 7. The spring 5 biases the second retainer 7 in one circumferential direction, and thus biases, through the second retainer 7, the rollers 10 in a direction to wedge the rollers 10 into the respective wedge-shaped spaces.

Since all the rollers 10 are biased by the elastic member 5 through the second retainer 7, it is not necessary to provide elastic members 5 each for one roller 10 (as disclosed in JP Patent Publication 2001-12512A.

The one-way clutch shown in FIG. 14 needs as many elastic members 5 as the rollers, and is thus costly. Also, it is troublesome to mount such a large number of elastic members 15.

In this arrangement, in order to prevent separation of the rollers 10 by passing radially inwardly through the radially inner openings of the respective pockets 3, the openings have a circumferential width w slightly smaller than the diameter d of the rollers 10.

This restricts the circumferential movement of the rollers 10, thereby restricting the moving range of the clutch between the locked and unlocked positions.

The one-way clutch shown in FIGS. 15A and 15B is free of this problem. That is, the rollers 10 are freely movable in the circumferential direction.

But in this arrangement, because the elastic member presses the rollers 10 against the respective cam surfaces 4 through the bridges 7b of the second retainer 7, which axially extend from the ring portion 7a, it is necessary to strictly control the accuracy of the pitches of the bridges 7b (distances between the circumferentially adjacent bridges 7b).

If there are large differences among the pitches of the bridges 7b, it may be difficult to simultaneously lock all the rollers. This deteriorates the locking capacity of the one-way clutch.

An object of the present invention is to provide a one-way clutch which can be easily manufactured and assembled and which can stably maintain high locking capacity.

### SUMMARY OF THE INVENTION

In order to achieve this object, the present invention provides a one-way clutch comprising an outer race and an inner race provided coaxially with each other and defining an annular space therebetween, the outer race having a radially inner surface facing the annular space and formed with a plurality of circumferentially inclined cam surfaces that are arranged in a row in a circumferential direction of the outer race, each of the cam surfaces defining a wedge-shaped space in cooperation with a radially outer surface of the inner race, clutch-actuating rollers 10 each disposed in one of the wedge-shaped spaces, and an elastic member disposed between the outer race and the inner race and biasing at least a group of the clutch-actuating rollers in one circumferential direction toward narrow ends of the respective wedge-shaped spaces, wherein at least one circumferentially adjacent pair of the group of the clutch-actuating rollers are in abutment with each other, whereby the biasing force applied from the elastic member to one of the at least one circumferentially adjacent pair of the group of the clutch-actuating rollers is transmitted to the other of the at least one circumferentially adjacent pair of the group of the clutch-actuating rollers.

In another arrangement, at least one load-bearing roller is disposed between a circumferentially adjacent pair of the group of the clutch-actuating rollers to transmit the biasing force of the elastic member to the clutch-actuating rollers.

More specifically, the one-way clutch of this arrangement comprises an outer race and an inner race provided coaxially with each other and defining an annular space therebetween, the outer race having a radially inner surface facing the annular space and formed with a plurality of circumferentially inclined cam surfaces that are arranged in a row in a circumferential direction of the outer race, each of the cam surfaces defining a wedge-shaped space in cooperation with a radially outer surface of the inner race, clutch-actuating rollers 10 each disposed in one of the wedge-shaped spaces, an elastic member disposed between the outer race and the inner race and biasing at least a group of the clutch-actuating rollers in one circumferential direction toward narrow ends of the respective wedge-shaped spaces, and at least one load-bearing roller disposed between a circumferentially adjacent pair of the group of the clutch-actuating rollers, and in abutment with an arcuate surface formed on the radially inner surface of the outer race between the adjacent cam surfaces corresponding to the circumferentially adjacent pair of the group of the clutch-actuating rollers, respectively, the arcuate surface being a portion of a cylindrical surface having its center located on a central axis of the outer race, whereby the biasing force applied from the elastic member to one of the circumferentially adjacent pair of the group of the clutch-actuating rollers is transmitted to the other of the circumferentially adjacent pair of the group of the clutch-actuating rollers through the at least one load-bearing roller.

In the former arrangement, at least one circumferentially adjacent pair of clutch-actuating rollers are in abutment with each other, whereby the biasing force applied from the elastic member to one of the pair of clutch-actuating rollers is directly transmitted to the other of the pair of clutch-actuating rollers. In the latter arrangement, at least one load-bearing roller is disposed between a circumferentially adjacent pair of clutch-actuating rollers, whereby the biasing force applied from the elastic member to one of the pair of clutch-actuating rollers is transmitted to the other of the pair of clutch-actuating rollers through the load-bearing roller. In either arrangement, the biasing force can be transmitted to a plurality of adjacent clutch-actuating rollers, not through a retainer.

Since a plurality of clutch-actuating rollers can be biased by a single elastic member, it is not necessary to provide one elastic member for every one of the clutch-actuating rollers. Thus, it is possible to reduce the number of elastic members provided between the inner and outer races, which in turn makes it possible to reduce the cost, save space, and easily assemble and manufacture the one-way clutch.

In one specific arrangement, the biasing force of the elastic member is transmitted to each of half or more of the clutch-actuating rollers through at least one other clutch-actuating roller.

With this arrangement, compared to the arrangement in which one elastic member is provided for every one of the clutch-actuating rollers, it is possible to reduce the number of elastic members to half or less.

A plurality of the load-bearing rollers may be disposed each between any circumferentially adjacent pair of the group of the clutch-actuating rollers.

By alternately arranging the clutch-actuating rollers and the load-bearing rollers in this manner, the clutch-actuating rollers can be densely arranged in the circumferential direction, so that it is possible to easily obtain a desired engaging force.

In order to transmit the biasing force applied to one of a circumferentially adjacent pair of clutch-actuating rollers to the other of the pair, one load-bearing roller may be disposed therebetween. Also, two, three or more load-bearing rollers may be disposed therebetween. Also, two or more circumferentially adjacent clutch-actuating rollers may be in abutment with each other with no load-bearing roller disposed therebetween.

To ensure uniform engaging force in the circumferential direction, the clutch-actuating rollers are preferably arranged circumferentially at pitches as equal to each other as possible. For this purpose, between each circumferentially adjacent pair of clutch-actuating rollers, it is preferable to provide the same number of load-bearing roller or rollers as the load-bearing roller or rollers between the other pairs of clutch-actuating rollers. Also, for this purpose, the load-bearing rollers are preferably all of the same diameter.

To each and every one of the clutch-actuating rollers that are biased by the common elastic member, the biasing force of the elastic member may be transmitted through the adjacent load-bearing roller located between this clutch-actuating roller and the elastic member. Otherwise, the biasing force of the elastic member may be directly transmitted to the clutch-actuating roller located nearest to the elastic member.

By transmitting the biasing force of the elastic member to all of the clutch-actuating rollers, it is possible to further reduce the number of elastic members, thereby reducing the cost and save space.

In the arrangement in which the biasing force of the single elastic member is transmitted to all of the clutch-actuating rollers, the clutch-actuating rollers and the load-bearing rollers may be alternately arranged with each other over the entire circumference.

In this case, in the same manner as described above, the clutch-actuating rollers are preferably arranged circumferentially at pitches as equal to each other as possible, and also, the load-bearing rollers are preferably all of the same diameter.

The clutch-actuating rollers may be of different diameters from each other. But they are preferably of the same diameter so that common rollers of the same shape and size can be used both for the clutch-actuating rollers and load-bearing rollers.

The one-way clutch preferably includes an anti-separation member for preventing the clutch-actuating rollers from radially inwardly separating from the clutch.

More specifically, the one-way clutch preferably further comprises an anti-separation member made of a resin or a metal and disposed between the outer race and the inner race, the anti-separation member comprising an annular portion extending circumferentially of the one-way clutch, and a plurality of legs axially extending from the annular portion and defining openings between the circumferentially adjacent legs, the openings having a circumferential width wide enough to allow the respective clutch-actuating rollers to protrude radially inwardly from the openings so as to be engageable with the inner race but narrow enough not to allow passage of the clutch-actuating rollers through the respective openings, whereby each of the clutch-actuating rollers is prevented from radially inwardly separating from the one-way clutch by the legs on both sides of the corresponding opening.

The anti-separation member prevents separation of the clutch-actuating rollers and the load-bearing rollers even while inner race such as a shaft is not inserted.

The distance between the center of each of the load-bearing rollers and the central axis of the outer race is preferably larger than the distance between the center of each of the clutch-actuating rollers and the central axis of the outer race.

With this arrangement, as long as the clutch-actuating rollers are prevented from radially inwardly separating from the clutch, the load-bearing rollers, which are each supported by the clutch-actuating rollers on both sides, do not radially inwardly separate from the clutch, either. In this arrangement, since it is not necessary to bring the load-bearing rollers into direct contact with the anti-separation member, it is possible to simplify the structure of the anti-separation member.

But the anti-separation member may be in direct contact with the load-bearing rollers. Specifically, the legs of the anti-separation member may have radially outer surfaces which are portions of a cylindrical surface having its center located on the central axis of the outer race, and radially inner surfaces which are portions of a cylindrical surface having its center located on the central axis of the outer race, the legs having their radially outer surfaces in contact with the respective load-bearing rollers.

With this arrangement, the anti-separation member prevents separation of the load-bearing rollers by directly supporting the load-bearing rollers.

The anti-separation member is preferably circumferentially movable so that the anti-separation member does not restrict the circumferential movement of the respective rollers.

With this arrangement, it is possible to increase the locking range of the clutch-actuating rollers. This in turn allows a large tolerance for the inner race (shaft).

In the arrangement in which the anti-separation member is circumferentially movable, the legs of the anti-separation member may include supports which are in contact with the respective clutch-actuating rollers, thereby transmitting a circumferential movement of the clutch-actuating rollers to the anti-separation member.

With this arrangement, the anti-separation member can smoothly move circumferentially together with the clutch-actuating rollers when the latter move circumferentially. This prevents the possibility of the anti-separation member getting stuck between the clutch-actuating rollers and the inner race.

The supports may comprise inclined flat surfaces extending circumferentially radially outwardly from the respective openings, and in contact with the respective clutch-actuating rollers. With this arrangement, it is possible to more easily transmit the circumferential movement of the clutch-actuating rollers to the anti-separation member.

The inclined surfaces may be arcuate surfaces that are in surface contact with outer peripheries of the respective clutch-actuating rollers. With this arrangement, the supports and the clutch-actuating rollers can be more closely brought into contact with each other, so that movement of the clutch-actuating rollers is more smoothly transmitted to the anti-separation member.

The inclined surfaces may be flat surfaces each in contact with an outer periphery of the corresponding clutch-actuating roller along a line parallel to the axis of the clutch-actuating roller.

With this arrangement, the circumferential movement of the clutch-actuating rollers can be more smoothly transmitted to the anti-separation member.

Preferably, as viewed from the axial direction of the clutch-actuating rollers, a tangent at the contact point between each flat surface and the corresponding clutch-actuating roller forms an angle of not more than 70 degrees with a line connecting the center of the corresponding clutch-actuating roller and the central axis of the outer race.

In an alternative arrangement, chamfers are formed along ridges between an outer periphery and axial end surfaces of each clutch-actuating roller, and there are two of the anti-separation members that are provided at two opposed axial ends of the outer race, the legs of each of the anti-separation members extending axially inwardly beyond the chamfers toward the axial centers of the clutch-actuating rollers and terminating at or short of the axial centers of the clutch-actuating rollers.

With this arrangement, because there are provided anti-separation members at both axial ends of the clutch-actuating rollers, compared to the arrangement in which a single anti-separation member is provided at one axial end, it is possible to reduce the total axial length of the legs from the respective annular portions, while stably supporting the clutch-actuating rollers. Such anti-separation members can be easily mounted to the clutch because it is not necessary to insert their legs deep into the clutch.

Preferably, the at least one load-bearing roller has the function of transmitting radial loads between the outer race and the inner race.

For this purpose, it is necessary that the total of the clearance between the load-bearing roller and the cylindrical surface of the outer race, and the clearance between the load-bearing surface and the outer peripheral surface of the inner race, or the clearance between the anti-separation member and the load-bearing surface and the clearance between the anti-separation member and the outer peripheral surface of the inner race, if the anti-separation member is used. The total of these clearances are set to an optimum value according to the properties of radial loads transmitted between the inner and outer races.

Load bearing portions may be provided at two respective axial ends of the annular space for transmitting radial loads between the outer race and the inner race.

Such load-bearing portions may be provided irrespective of whether or not the load-bearing roller has the function of transmitting radial loads.

Preferably, at least one of the two axial ends of the annular space is closed by an annular plate pressed into the outer race. With this arrangement, it is possible to press the annular plate into the outer race after mounting the clutch-actuating rollers and the at least one load-bearing roller. This makes it easier to mount the rollers and the anti-separation member (if any) in the outer race.

The annular portion of the anti-separation member may comprise a flange extending radially outwardly from axial ends of the legs along the inner end surface of the annular plate.

Such a radially outwardly extending flange serves to increase the diameter of the anti-separation member, thus making it difficult to mount such an anti-separation member in the outer race. But by arranging the flange so as to extend along the inner end surface of the annular plate, the anti-separation member can be received in the outer race before mounting the annular plate.

In the arrangement in which the legs of the anti-separation member have radially outer surfaces which are portions of a cylindrical surface having its center located on the central axis of the outer race, and radially inner surfaces which are portions of a cylindrical surface having its center located on the central axis of the outer race, the annular portion and the legs of the anti-separation member may be formed by annularly bending a single flexible sheet so as to be pressed against the load-bearing rollers, which are located radially outwardly of the anti-separation member, by its elasticity produced by bending the sheet.

With this arrangement, the anti-separation member is formed of a single sheet and simple in structure, and can be easily mounted in the outer race by bending the sheet.

According to the present invention, because the biasing force applied to one of the clutch-actuating rollers from the elastic member is transmitted to another circumferentially adjacent clutch-actuating roller through a load-bearing roller, no high dimensional accuracy is required for the retainer, through which the biasing force is transmitted in conventional arrangements. Thus, the one-way clutch can be easily manufactured and assembled. Still, it shows a high locking capacity.

### BRIEF DESCRIPTION OF THE DRAWINGS

Other features and objects of the present invention will become apparent from the following description made with reference to the accompanying drawings, in which:

FIG. 1A is a front view of a one-way clutch embodying the present invention;

FIG. 1B is a sectional view taken along line B-B of FIG. 1A;

FIG. 2 is an exploded perspective view of the embodiment of FIG. 1A;

FIGS. 3A and 3B are perspective views of an anti-separation member before and after being annularly bent, respectively;

FIG. 3C shows the positional relation between the anti-separation member and clutch-actuating rollers;

FIGS. 4A and 4B are partial sectional views of the clutch of FIG. 1A, showing its engaged and disengaged states, respectively;

FIG. 5A is a front view of another embodiment;

FIG. 5B is a perspective view of an anti-separation member used in the embodiment of FIG. 5A;

FIG. 5C is a partial enlarged front view of still another embodiment;

FIG. 6 is a side view of a further embodiment;

FIGS. 7A and 7B are partial enlarged views of yet further embodiments;

FIG. 8 is a side view of another embodiment;

FIGS. 9A to 9C are a perspective view, a side view and a front view of a different anti-separation member, respectively;

FIGS. 10A and 10B are a front view and a side view of an embodiment in which the anti-separation member shown in FIGS. 9A to 9C is used;

FIG. 10C is a partial enlarged view of FIG. 10B;

FIGS. 11A and 11B are front views of other embodiments in which the anti-separation member of FIGS. 9A to 9C is used;

FIG. 12A is a side view of another embodiment;

FIG. 12B is a partial enlarged view of FIG. 12A;

FIG. 13 is a side view of still another embodiment;

FIG. 14 is a partially cutaway side view of a conventional one-way clutch; and

FIGS. 15A and 15B are partial enlarged views of a conventional one-way clutch, showing its disengaged and engaged states, respectively.

### DETAILED DESCRIPTION OF THE PREFERRED EMBODIMENTS

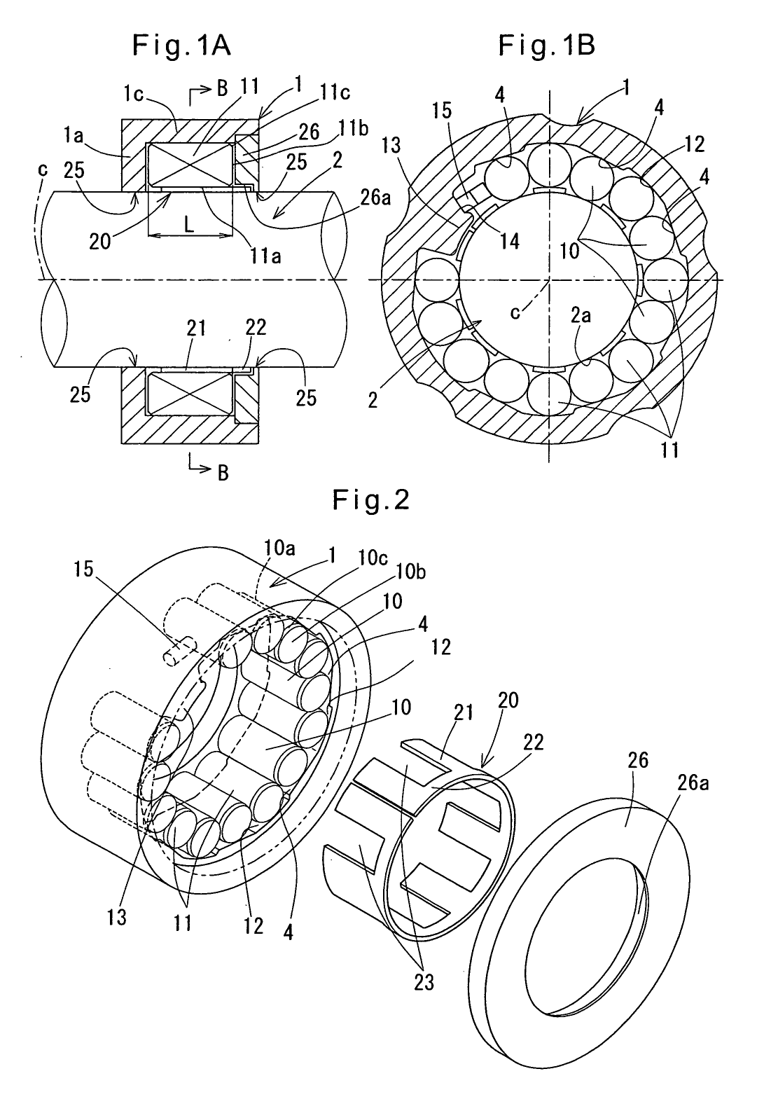

An embodiment of the invention is now described with reference to FIGS. 1 to 4. As shown in FIGS. 1A and 1B, the one-way clutch of this embodiment includes an annular outer race 1 and a shaft (inner race) which have a common central axis c.

The inner race 2 may be a shaft as shown, or may be an annular ring to which another shaft is coupled by fitting.

As shown in FIG. 1A, the outer race 2 comprises an outer cylindrical portion 1c and an end wall 1a extending radially inwardly from the left-hand (in the figure) end (this end is referred to as the “first axial end”) of the outer cylindrical portion 1c, and thus has an L-shaped section. The end wall 1a is integral with the outer cylindrical portion 1c.

An annular plate 26 is pressed into the outer cylindrical portion 1c at its right-hand (in the figure) end (this end is referred to as the “second axial end”). The outer cylindrical portion 1c is subjected to heat treatment for increasing the hardness of its radially inner surface.

The radially inner surfaces of the end wall 1a and the plate 26 have such a diameter that a very small gap is present between the respective radially inner surfaces and the cylindrical outer periphery 2a of the shaft 2, thereby forming load bearing portions 25 between the respective radially inner surfaces and the cylindrical outer periphery 2a of the shaft 2 through which radial loads are transmitted between the shaft 2 and the outer race 1.

An annular space is defined between the outer race 1 and the shaft 2. On the radially inner surface of the cylindrical outer portion 1c defining the annular space, a plurality of circumferentially inclined cam surfaces 4 are formed at equal circumferential intervals. As shown in FIG. 1B, each cam surface 4 is inclined such that its portion closer to its right-hand (in the figure) circumferential end is located closer to the axis c of the outer race 1. Thus, a circumferentially wedge-shaped space is defined between each cam surface 4 and the cylindrical outer surface 2a of the shaft 2.

Between circumferentially adjacent cam surfaces 4, arcuate surfaces are formed which are portions of a cylindrical surface 12 having its center located on the axis c of the outer race 1. The cylindrical surface 12 has a diameter which is slightly larger than the diameter of the maximum-diameter portions of the cam surfaces 4.

One clutch-actuating roller 10 is received in each wedge-shaped space. Between each of the circumferentially adjacent pairs of clutch-actuating rollers 10, at least one load-bearing roller 11 is provided. Thus, the clutch-actuating rollers 10 and the load-bearing rollers 11 are basically alternately arranged over the entire circumference. The clutch-actuating rollers 10 and the load-bearing rollers 11 are identical to each other, having diameters D and lengths L that are equal to each other.

In FIG. 1B, however, between one circumferentially adjacent pair of clutch-actuating rollers 10, two load-bearing rollers 11 are disposed. The number of load-bearing rollers 11 between any given circumferentially adjacent rollers 10 may be changed as shown in FIG. 1B to adjust the circumferential positions of the clutch-actuating rollers 10.

The load-bearing rollers 11 have their radially outer portions in abutment with the respective arcuate portions of the cylindrical surface 12 between the adjacent cam surfaces 4, and have their radially inner portions in abutment with an anti-separation member 20 provided radially inwardly of the load-bearing rollers 11.

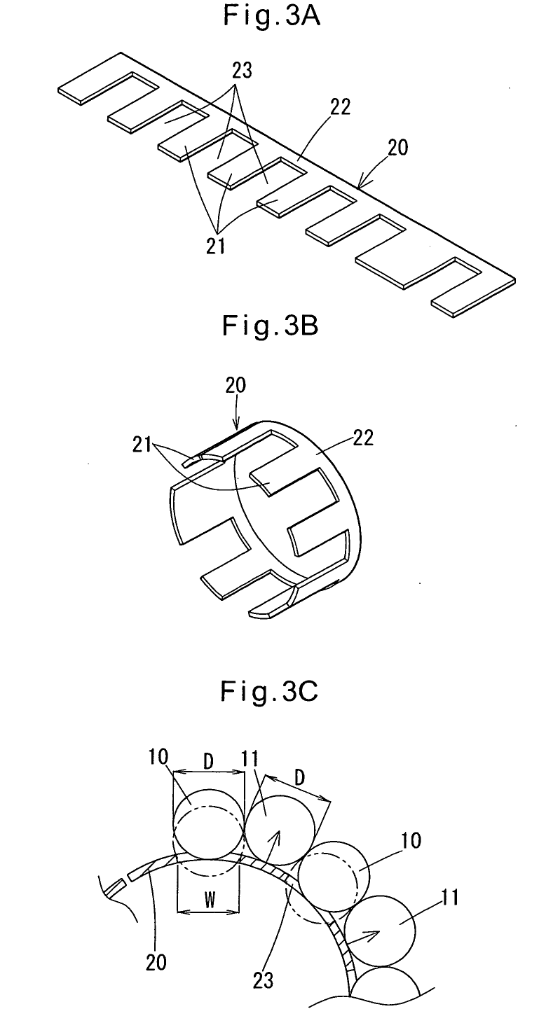

As shown in FIG. 2, the anti-separation member 20 comprises an annular portion 22, and a plurality of legs 21 which are portions of a cylinder having its center located on the axis c of the outer race 1. As shown in FIGS. 3A and 3B, the anti-separation member 20 is formed by annularly bending a flexible resin or metal sheet having a uniform thickness over the entire area, and is pressed against the load-bearing rollers 11 as shown by the arrows in FIG. 3C by its elasticity produced by bending the sheet.

Between each adjacent pair of legs 21, an opening 23 having a circumferential width W smaller than the diameter D of the clutch-actuating rollers 10 is defined.

Since the openings 23 have a circumferential width W smaller than the diameter D of the clutch-actuating rollers 10, the clutch-actuating rollers 10 are opposed to the outer periphery 2a of the shaft 2 through the openings 23 so as to be engageable with the outer periphery 2a, but never pass through the openings 23 and separate from the bearing while the shaft 2 is not inserted (state shown by chain line in FIG. 3C).

As shown in FIG. 1A, the annular portion 22 of the anti-separation member 20 is received in a recess 26a formed in the radially inner surface of the plate 26 and held in position between the radially inner surface of the recess 26a and the cylindrical outer periphery 2a of the shaft 2 so as to be circumferentially movable.

The clutch-actuating rollers 10 and the load-bearing rollers 11 have equal diameters D, and the distance r2 between the centers d of the load-bearing rollers 11 and the axis c is larger by the distance equal to the radial thickness V of the legs 21 than the distance r1 between the centers e of the clutch-actuating rollers 10 and the axis c.

One spring (elastic member) 15 is provided in the annular space between the outer race 1 and the shaft 2.

The spring 15 is fitted in position in a spring support 14 of a radially inwardly extending protrusion 13 on the outer race 1, with its free end directly in contact with the clutch-actuating roller 10 located nearest to the spring 15. The spring 15 is held in this position in a compressed state.

Thus, the spring 15 tends to elastically expand and circumferentially biases this clutch-actuating roller 10 toward the narrow end of the wedge-shaped space.

Any adjacent pair of clutch-actuating rollers 10 are in contact with the load-bearing roller 11 therebetween. Thus, when the clutch-actuating roller 10 in contact with the spring 15 is biased circumferentially toward the narrow end of the wedge-shaped space, all the other clutch-actuating rollers 10 are also equally circumferentially biased by the spring 15 through the load-bearing rollers 11.

That is, the biasing force of the spring 15 is transmitted first to the nearest clutch-actuating roller 10 and then to the other clutch-actuating rollers 10 one after another through the load-bearing rollers 11 until the biasing force is transmitted to all the clutch-actuating rollers 10. Thus, all the clutch-actuating rollers 10 are biased by the single elastic member 15.

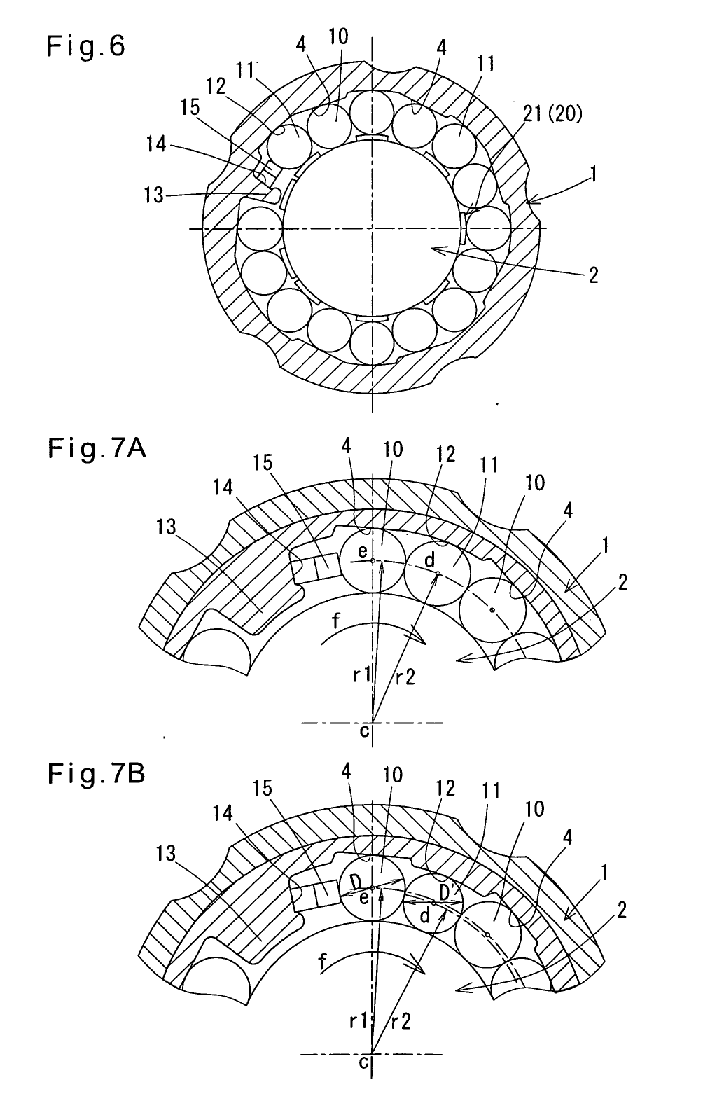

In this embodiment, the spring 15, which comprises a coil spring, is in direct contact with the nearest clutch-actuating roller 10. But instead, as shown in FIG. 6, the coil spring 15 may be brought into direct contact with one of the load-bearing rollers 11 that is located nearest to the spring.

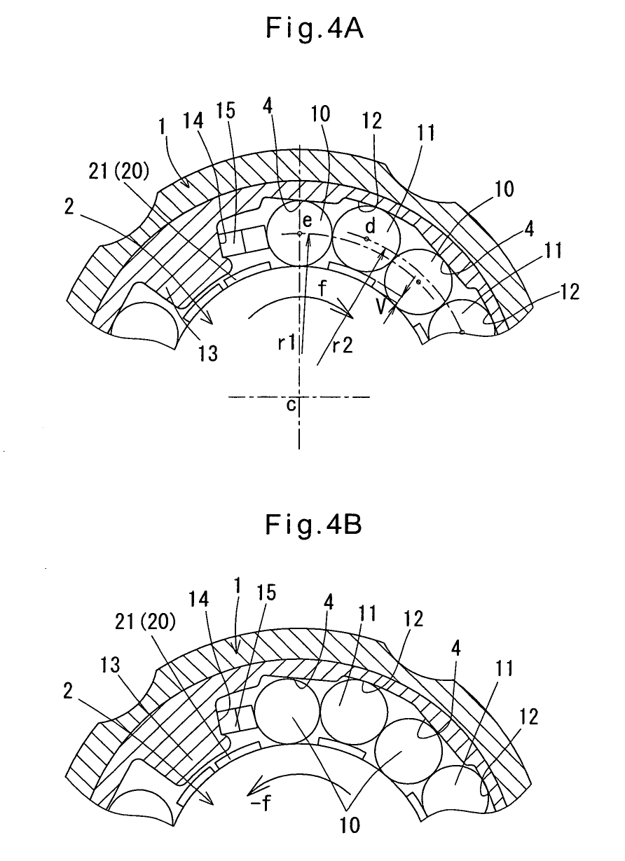

The operation of this one-way clutch is now described. Suppose here that torque is transmitted from the shaft 2 to the outer race 1. As shown in FIG. 4A, if the shaft 2 is rotated in the direction shown by the arrow f, the clutch-actuating rollers 10 move toward the radially narrow ends of the respective wedge-shaped spaces, thus engaging the clutch. The outer race 1 is now rotated in the same direction as the shaft 2 (i.e. the direction of the arrow f).

If, as shown in FIG. 4B, the shaft 2 is rotated in the direction of the arrow −f, the clutch-actuating rollers 10 move toward the radially wide ends of the respective wedge-shaped spaces, thus disengaging the clutch. In this state, the torque of the shaft 2 is not transmitted to the outer race 1.

Now suppose that torque is transmitted from the outer race 1 to the shaft 2. In this state, conversely to the above, if the outer race 1 is rotated in the direction of the arrow −f, the clutch engages and the shaft 2 is rotated in the same direction as the outer race 1 (i.e. the direction of the arrow −f). If the outer race 1 is rotated in the opposite direction (direction of the arrow f), the clutch disengages, so that the torque of the outer race 1 is not transmitted to the shaft 2.

Because all of the clutch-actuating rollers 10 and the load-bearing rollers 11 are always kept in abutment with the adjacent rollers, it is possible to minimize the differences among moving distances (angular distances about the axis c) of the respective clutch-actuating rollers 10 and the respective load-bearing rollers 11. This makes substantially uniform the forces by which the respective clutch-actuating rollers 10 engage, thereby allowing stable locking of the clutch.

As the clutch-actuating rollers 10 and the load-bearing rollers 11 move circumferentially, the anti-separation member 20 also moves circumferentially, so that the anti-separation member 20 never restricts the circumferential movement of the rollers 10 and 11.

Thus, the clutch-actuating rollers can circumferentially move a long distance between the position where the clutch engages and the position where the clutch disengages. This in turn allows a large tolerance for the shaft 2.

To assemble the one-way clutch, as shown in FIG. 2, the spring 15, the clutch-actuating rollers 10 and the load-bearing rollers 11 are received one after another in the outer race 1 such that the clutch-actuating rollers 10 are brought into abutment with the respective cam surfaces 4 and the load-bearing rollers 11 are brought into abutment with the cylindrical surface 12.

Then, the anti-separation member 20 in the form of a sheet is annularly bent, and inserted into the outer race so as to be located radially inwardly of the clutch-actuating rollers 10 and the load-bearing rollers 11. Since the anti-separation member 20 is bent annularly in this state, it tends to radially expand, so that its legs 21 are pressed against the load-bearing rollers 11.

Then, the plate 26 is pressed into the second axial end of the outer cylindrical portion 1c of the outer race 1, with the annular portion 22 of the anti-separation member 20 received in the recess 26a of the plate 26.

Because the shaft 2 is e.g. a rotary shaft of a device, the shaft 2 is inserted after all the other elements of the one-way clutch have been assembled. But even without the shaft 2, the anti-separation member 20 prevents separation of the rollers 10 and 11.

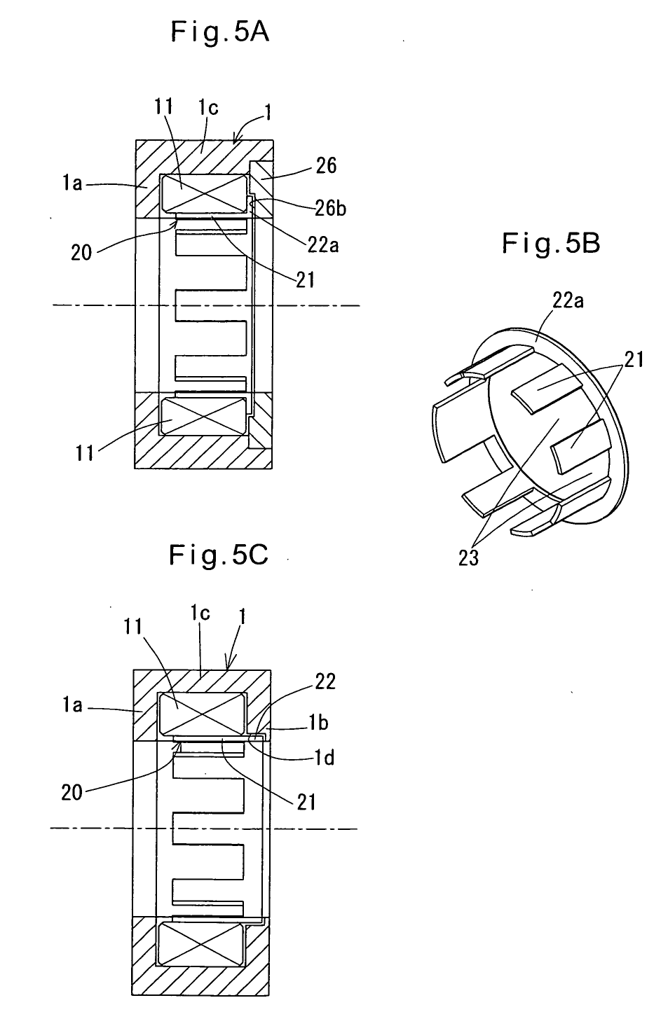

FIGS. 5A and 5B show another embodiment. In this embodiment, the annular portion of the anti-separation member 20 is a flange 22a extending radially outwardly from axial ends of the legs 21. The anti-separation member 20 is made of a rigid plastic or a metal, so that it is less likely to be elastically deformable than the anti-separation member 20 of the first embodiment, which is in the form of a sheet.

Although the anti-separation member 20 may be made of a flexible resin, in order to positively prevent separation of the rollers 10 and 11, the anti-separation member 20 has to have rigidity sufficient to support the weight of the rollers 10 and 11.

The flange 22a of the anti-separation member 20 of this embodiment is received in a recess 26b formed in the inner end surface of the plate 26, and supported along the inner end surface of the recess 26b. The anti-separation member 20 is thus rotatably supported by the plate 26.

FIG. 5C shows still another embodiment, in which instead of the plate 26, which closes the second axial end of the outer race 1, an end wall 1b is integrally formed on the outer cylindrical portion 1c of the outer race 1 at its second axial end. Thus, the outer race 1 comprises the outer cylindrical portion 1c and the end walls 1a and 1b at both axial ends of the outer cylindrical portion 1c, and has a U-shaped section.

The annular portion 22 of the anti-separation member 20, which is in the form of a sheet, is received and held in position in a recess 1d formed in the radially inner surface of the end wall 1b at the second axial end.

In the embodiment shown in FIG. 7A, the anti-separation member 20 is omitted. The clutch-actuating rollers 10 and the load-bearing rollers 11 have the same diameter D, and the distance r2 between the centers d of the load-bearing rollers 11 and the axis c is equal to the distance r1 between the centers e of the clutch-actuating rollers 10 and the axis c.

In the embodiment shown in FIG. 7B, the anti-separation member 20 is omitted, and the load-bearing rollers 11 has a diameter D′ slightly smaller than the diameter D of the clutch-actuating rollers 10. Thus, the distance r2 between the centers d of the load-bearing rollers 11 and the axis c is slightly smaller than the distance r1 between the centers e of the clutch-actuating rollers 10 and the axis c.

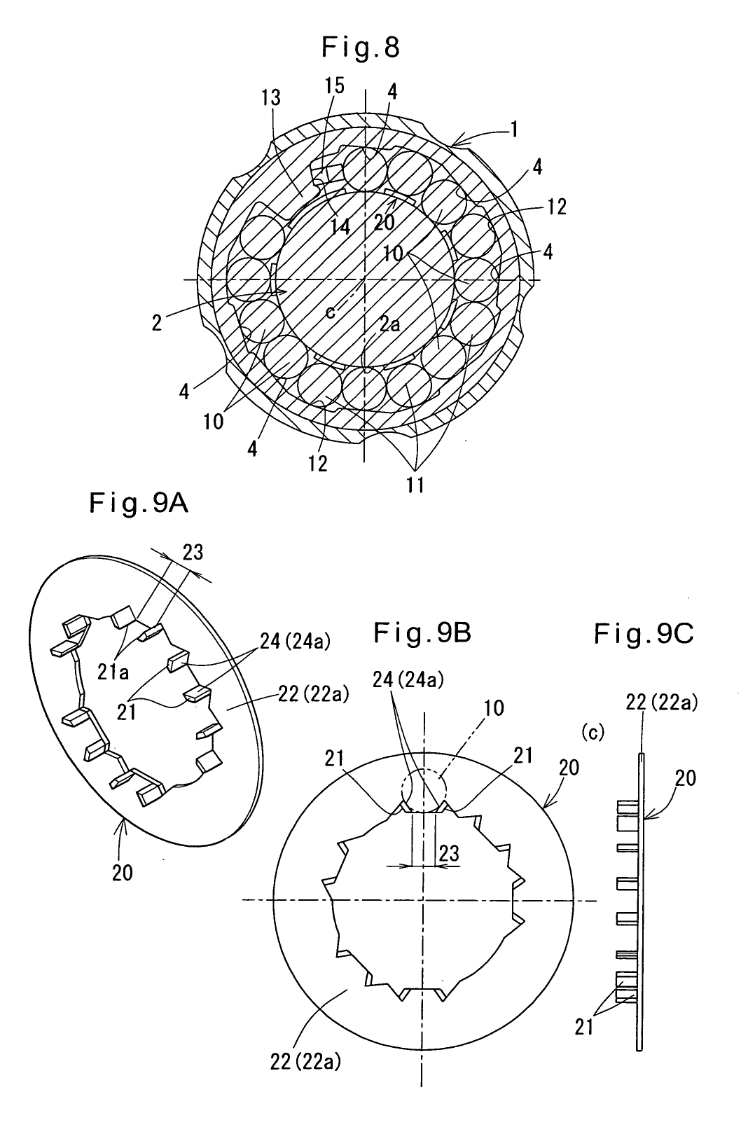

In another embodiment, as shown in FIG. 8, one or more of the circumferentially adjacent pairs of clutch-actuating rollers 10 are in direct contact with each other with no load-bearing roller 11 disposed therebetween. In FIG. 8, only one circumferentially adjacent pair of clutch-actuating rollers 10 are in direct contact with each other. But two, three, four or more of the circumferentially adjacent pairs of clutch-actuating rollers 10 may be in direct contact with each other.

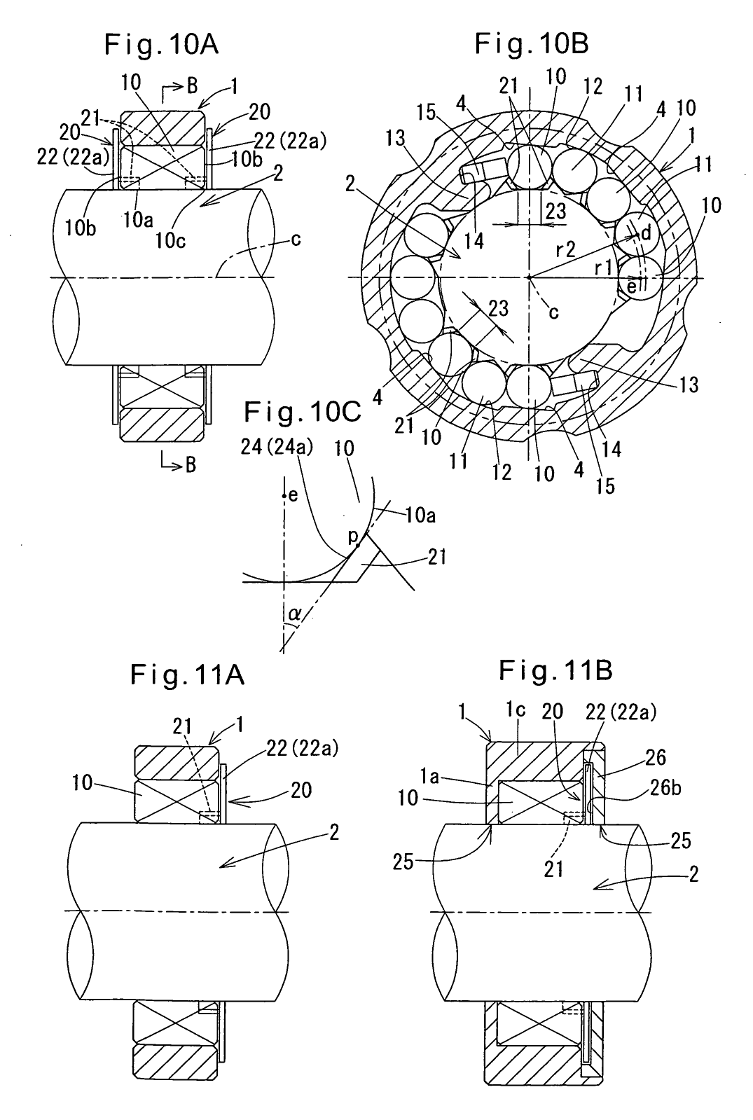

FIGS. 9A to 9C and 10A to 10C show a further embodiment. As shown in FIG. 10A, the one-way clutch of this embodiment includes two anti-separation members 20 that are provided on the respective axial ends thereof. The two anti-separation members 20 are made of the same material, and are identical in shape and size to each other.

The anti-separation members 20 each comprise an annular portion 22 in the form of a flange 22a, and legs 21 axially extending in the same direction from the radially inner edge of the flange 22a. The radially outer surfaces of the legs 21 serve as supports 24 that abut the clutch-actuating rollers 10.

Further, in this embodiment, the clutch-actuating rollers 10 are biased toward their engaging positions by two elastic members 15. Compared to the other embodiments, in which the clutch-actuating rollers 10 are biased with a single elastic member 15, it is possible to apply more uniform biasing forces to the respective clutch-actuating rollers, though one extra elastic member is necessary.

As shown in FIG. 9A, between opposed edges 21a of the circumferentially adjacent pairs of legs 21, openings 23 are defined having a circumferential width smaller than the diameter of the clutch-actuating rollers 10. The clutch-actuating rollers 10 protrude through the openings 23 and are selectively engageable with the outer periphery 2a of the inner race 2.

Like the anti-separation members of the other embodiments, the anti-separation members 20 of this embodiment are made of a rigid resin or a metal, i.e. a material having rigidity sufficient to support the weight of the rollers 10 and 11. Thus, the clutch-actuating rollers 10 are each supported by the supports 24 on both sides of the corresponding opening 23 and prevented from passing radially inwardly through the openings 23.

The supports 24 each comprise an inclined flat surface 24a extending circumferentially radially outwardly from the corresponding opening 23 toward the outer race 1, and in contact with the outer periphery 10a of the corresponding clutch-actuating roller 10 along an axial line.

As shown in FIG. 10C, as viewed from the axial direction, the line connecting the center e of each clutch-actuating roller 10 and the axis c forms an angle α with the tangent at the contact point p between the roller 10 and the corresponding flat surface 24a. In the embodiment shown, this angle α is set at 70 degrees or less.

Through the contact points p between the outer peripheries 10a of the clutch-actuating rollers 10 and the respective supports 24, the circumferential movement of the clutch-actuating rollers 10 is transmitted to the anti-separation members 20.

Thus, with the circumferential movement of the clutch-actuating rollers 10, the supports 24 are pushed circumferentially, so that the anti-separation members 20 are circumferentially moved. This prevents the anti-separation members 20 from getting stuck between the clutch-actuating rollers 10 and the inner race 2.

Also, by setting the angle α at 70 degrees or less, the movement of the clutch-actuating rollers 10 can be reliably converted to the movement of the anti-separation members 20.

Because the supports 24 are provided on both circumferential sides of the respective openings 23, the anti-separation members 20 can cope with either circumferential movement of the clutch-actuating rollers 10.

By using the two anti-separation members 20, it is possible to reduce the sliding surface area between the inner race 2 and the anti-separation members 20, so that it is possible to easily control torque while the clutch is overrunning.

Each clutch-actuating roller 10 is formed with chamfers 10c along the respective ridges between the outer periphery 10a and the axial end surfaces 10b thereof. Because the load-bearing rollers 11 are identical in shape and size to the clutch-actuating rollers 10, the load-bearing rollers 11 are also formed with chamfers 11c along the respective ridges between the outer periphery 11a and the axial end surfaces 11b thereof.

The anti-separation members 20 are inserted into the outer race from both ends such that the legs 21 of the anti-separation members 20 extend axially inwardly beyond the respective chamfers 10c and 11c but do not reach the axial centers of the clutch-actuating rollers 10.

Thus, it is possible to minimize the sum of the axial support lengths of each clutch-actuating roller 10 by the legs 21, so that the anti-separation members 20 can be mounted easily. Still, the clutch-actuating rollers 10 can be stably supported.

FIGS. 10A and 10B show the one-way clutch of this embodiment in the assembled state. In this state, the outer race is mounted to an external device in the same manner as the other embodiments. Even while the inner race 2 is not yet mounted, the clutch-actuating rollers 10 never separate from the assembly because they are supported by the legs 21 of the anti-separation members 20.

Because the distance r2 between the centers d of the load-bearing rollers 11 and the axis c of the one-way clutch (outer race) is larger than the distance r1 between the centers e of the clutch-actuating rollers 10 and the axis c, and because the clutch-actuating rollers 10 are inseparably supported by the legs 21, the load-bearing rollers 11, which are held in position by the clutch-actuating rollers 10 on both sides thereof and the inner periphery 1a of the outer race 1a, are also inseparable.

The legs 21 of each of the anti-separation members 20 may have their free ends located on the axial centers of the clutch-actuating rollers so as to be in abutment with the free ends of the legs 21 of the other anti-separation member 20.

As shown in FIG. 11A, only one of the anti-separation members 20 shown in FIGS. 9A-9C and 10A-10B may be provided on one axial end of the one-way clutch.

FIG. 11B shows a different anti-separation member 20, which includes, like the embodiment shown in FIG. 5A, a flange 22a received in a recess 26b formed in the inner end surface of the plate 26, and supported along the inner end surface of the recess 26b. The anti-separation member 20 is thus rotatably supported by the plate 26.

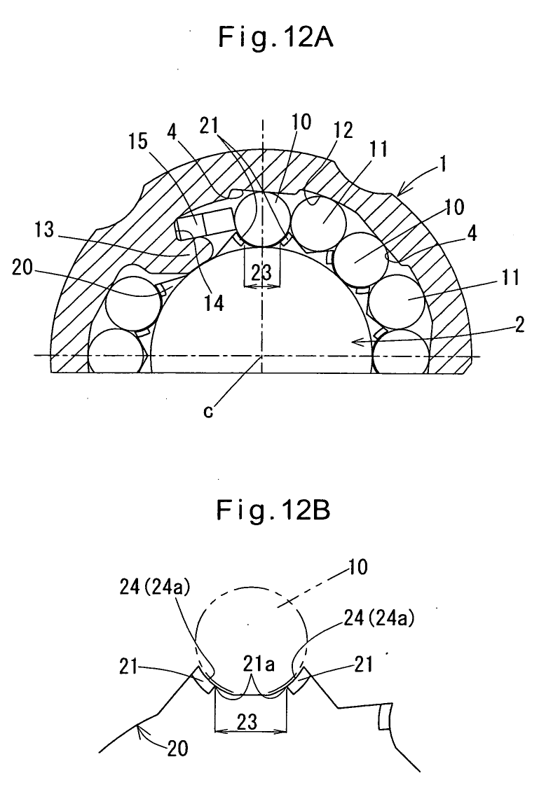

FIGS. 12A and 12B show still another embodiment, which includes an anti-separation member 20 similar to the anti-separation members 20 of the embodiment of FIGS. 9A-9C and 10A-10B except that the inclined surfaces 24a are arcuate surfaces that are brought into surface contact with the outer peripheries 10a of the clutch-actuating rollers 10.

Because the inclined surfaces 24a of the supports 24 are arcuate surfaces that are brought into surface contact with the clutch-actuating rollers 10, the supports 24 can more stably support the clutch-actuating rollers 10, thereby making it possible to more reliably transmit the movement of the clutch-actuating rollers 10 to the anti-separation member 20.

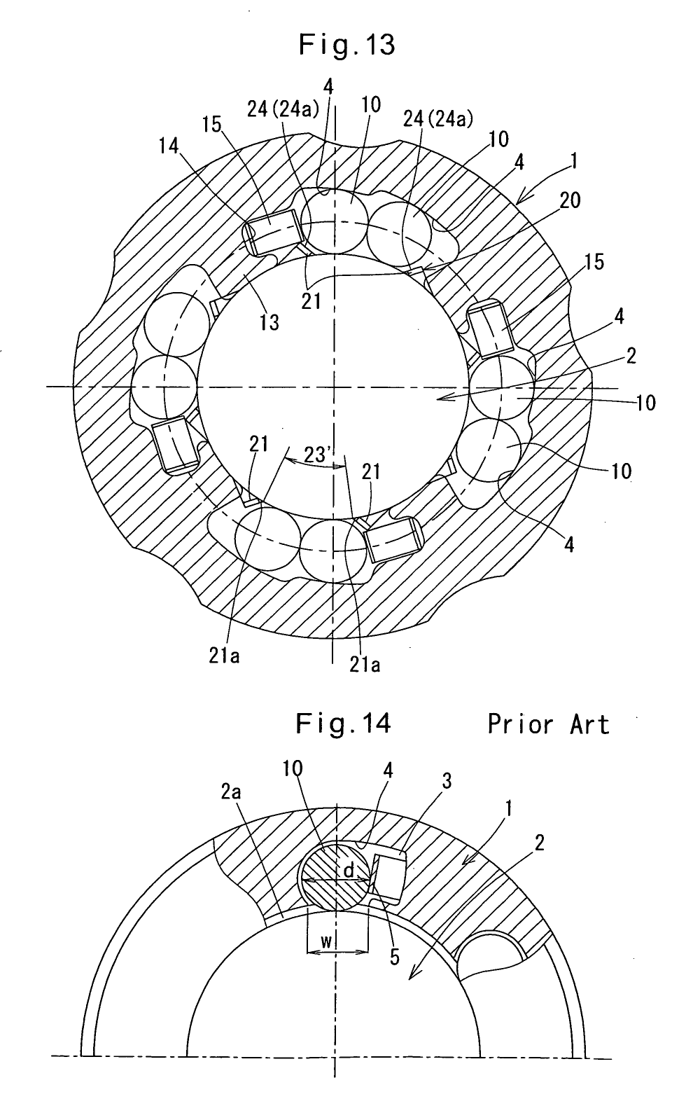

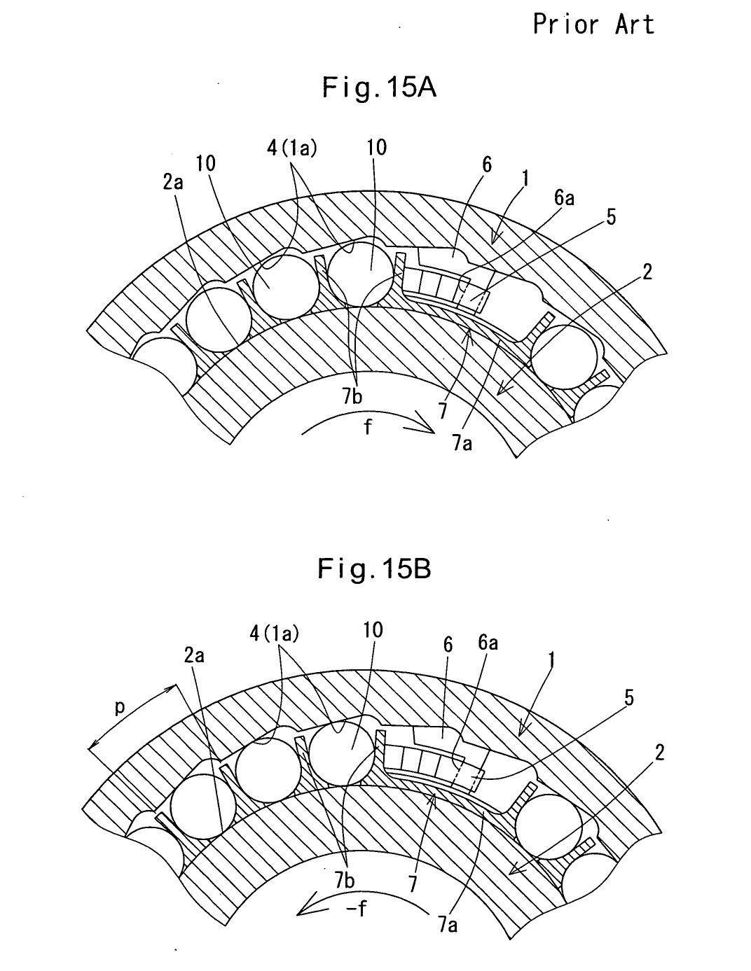

FIG. 13 shows a further embodiment, which includes circumferentially adjacent pairs of clutch-actuating rollers 10, each pair being in abutment with each other and biased by an elastic member 15.

In the specific arrangement shown, the one-way clutch includes four circumferentially adjacent pairs of such clutch-actuating rollers 10, and four elastic members 15 bias the four pairs of rollers 10, respectively. No load-bearing roller 11 is disposed between any of the four pairs of clutch-actuating rollers 10.

Because the four elastic members 15 are used, compared to the embodiment shown in FIG. 10B, in which two elastic members 15 are used or the embodiments in which all the clutch-actuating rollers 10 are biased by a single elastic member 15, such as shown in FIGS. 1, 6 and 8, the biasing force of the elastic members 15 can be more directly transmitted to the respective clutch-actuating rollers 10. Thus, if the torque bearing capacity is the same, the one-way clutch of this embodiment can be more strongly locked.

Each pair of clutch-actuating rollers 10 are supported by the supports 24 on both sides of an opening 23′ shown in FIG. 13, so that the rollers 10 are prevented from radially inwardly separating from the one-way clutch.

In particular, the openings 23′, which are defined between the opposed edges 21a of the circumferentially adjacent legs 21, have a circumferential width small enough not to allow each pair of clutch-actuating rollers 10 to simultaneously pass through the corresponding opening 23′, thus separating from the one-way clutch.

Each pair of clutch-actuating rollers 10 protrude through the corresponding opening 23′ and are selectively engageable with the outer periphery 2a of the inner race 2.

In the embodiment of FIG. 13, each circumferentially adjacent pair of clutch-actuating rollers 10 are in abutment with each other so that the biasing force of the corresponding elastic member 15 is transmitted to the two clutch-actuating rollers 10. But instead, the clutch-actuating rollers 10 may be divided into a plurality of groups each comprising three or more of circumferentially adjacent rollers that are in abutment with each other and biased by a single elastic member 15.

What is claimed is:

1. A one-way clutch comprising an outer race and an inner race provided coaxially with each other and defining an annular space therebetween;
said outer race having a radially inner surface facing said annular space and formed with a plurality of circumferentially inclined cam surfaces that are arranged in a row in a circumferential direction of the outer race;
each of said cam surfaces defining a wedge-shaped space in cooperation with a radially outer surface of said inner race;
clutch-actuating rollers 10 each disposed in one of said wedge-shaped spaces; and
an elastic member disposed between said outer race and said inner race and biasing at least a group of said clutch-actuating rollers in one circumferential direction toward narrow ends of the respective wedge-shaped spaces;
wherein at least one circumferentially adjacent pair of said group of said clutch-actuating rollers are in abutment with each other, whereby the biasing force applied from said elastic member to one of said at least one circumferentially adjacent pair of said group of said clutch-actuating rollers is transmitted to the other of said at least one circumferentially adjacent pair of said group of said clutch-actuating rollers.

2. A one-way clutch comprising an outer race and an inner race provided coaxially with each other and defining an annular space therebetween;
said outer race having a radially inner surface facing said annular space and formed with a plurality of circumferentially inclined cam surfaces that are arranged in a row in a circumferential direction of the outer race;
each of said cam surfaces defining a wedge-shaped space in cooperation with a radially outer surface of said inner race;
clutch-actuating rollers 10 each disposed in one of said wedge-shaped spaces;
an elastic member disposed between said outer race and said inner race and biasing at least a group of said clutch-actuating rollers in one circumferential direction toward narrow ends of the respective wedge-shaped spaces; and
at least one load-bearing roller disposed between a circumferentially adjacent pair of said group of said clutch-actuating rollers, and in abutment with an arcuate surface formed on said radially inner surface of said outer race between the adjacent cam surfaces corresponding to said circumferentially adjacent pair of said group of said clutch-actuating rollers, respectively, said arcuate surface being a portion of a cylindrical surface having its center located on a central axis of said outer race, whereby the biasing force applied from said elastic member to one of said circumferentially adjacent pair of said group of said clutch-actuating rollers is transmitted to the other of said circumferentially adjacent pair of said group of said clutch-actuating rollers through said at least one load-bearing roller.

3. The one-way clutch of claim 1 wherein the biasing force of said elastic member is transmitted to each of half or more of said clutch-actuating rollers through at least one other clutch-actuating roller.

4. The one-way clutch of claim 2 wherein a plurality of the load-bearing rollers are disposed each between any circumferentially adjacent pair of said group of said clutch-actuating rollers.

5. The one-way clutch of claim 1 wherein the biasing force of said elastic member is transmitted to all of said clutch-actuating rollers.

6. The one-way clutch of claim 2 wherein said clutch actuating rollers and said at least one load-bearing roller have diameters equal to each other.

7. The one-way clutch of claim 4 further comprising an anti-separation member made of a resin or a metal and disposed between said outer race and said inner race, said anti-separation member comprising an annular portion extending circumferentially of the one-way clutch, and a plurality of legs axially extending from said annular portion and defining openings between the circumferentially adjacent legs, said openings having a circumferential width wide enough to allow the respective clutch-actuating rollers to protrude radially inwardly from the openings so as to be engageable with said inner race but narrow enough not to allow passage of the clutch-actuating rollers through the respective openings, whereby each of the clutch-actuating rollers is prevented from radially inwardly separating from the one-way clutch by the legs on both sides of the corresponding opening.

8. The one-way clutch of claim 7 wherein the distance between the center of each of said load-bearing rollers and said central axis of said outer race is larger than the distance between the center of each of said clutch-actuating rollers and the central axis of said outer race.

9. The one-way clutch of claim 8 wherein said legs have radially outer surfaces which are portions of a cylindrical surface having its center located on the central axis of the outer race, and radially inner surfaces which are portions of a cylindrical surface having its center located on the central axis of the outer race, said legs having their radially outer surfaces in contact with the respective load-bearing rollers.

10. The one-way clutch of claim 7 wherein said anti-separation member is circumferentially movable.

11. The one-way clutch of claim 10 wherein said legs of said anti-separation member include supports which are in contact with the respective clutch-actuating rollers, thereby transmitting a circumferential movement of said clutch-actuating rollers to said anti-separation member.

12. The one-way clutch of claim 11 wherein said supports comprise inclined flat surfaces extending circumferentially radially outwardly from the respective openings, and in contact with the respective clutch-actuating rollers.

13. The one-way clutch of claim 12 wherein said inclined surfaces are arcuate surfaces that are in surface contact with outer peripheries of the respective clutch-actuating rollers.

14. The one-way clutch of claim 12 wherein said inclined surfaces are flat surfaces each in contact with an outer periphery of the corresponding clutch-actuating roller along a line parallel to the axis of the clutch-actuating roller.

15. The one-way clutch of claim 14 wherein as viewed from the axial direction of the clutch-actuating rollers, a tangent at the contact point between each flat surface and the corresponding clutch-actuating roller forms an angle of not more than 70 degrees with a line connecting the center of the corresponding clutch-actuating roller and the central axis of the outer race.

16. The one-way clutch of claim 7 wherein chamfers are formed along ridges between an outer periphery and axial end surfaces of each clutch-actuating roller, and wherein there are two of the anti-separation members that are provided at two opposed axial ends of the outer race, the legs of each of said anti-separation members extending axially inwardly beyond the chamfers toward the axial centers of said clutch-actuating rollers and terminating at or short of the axial centers of said clutch-actuating rollers.

17. The one-way clutch of claim 2 wherein said at least one load-bearing roller serves to transmit radial loads between said outer race and said inner race.

18. The one-way clutch of claim 1 wherein load-bearing portions are provided at two respective axial ends of said annular space for transmitting radial loads between said outer race and said inner race.

19. The one-way clutch of claim 7 wherein at least one of said two axial ends of said annular space is closed by an annular plate pressed into said outer race.
